(19) United States
(12) Patent Application Publication
(10) Pub. No.: US 2013/0268405 A1
(43) Pub. Date: Oct. 10, 2013

(54) INFORMATION INTEGRATION INTERACTIVE SYSTEM AND METHOD

(71) Applicant: Wei-Yen Yeh, Taipei (TW)

(72) Inventor: Wei-Yen Yeh, Taipei (TW)

(21) Appl. No.: 13/489,749

(22) Filed: Jun. 6, 2012

(30) Foreign Application Priority Data
Apr. 6, 2012 (TW) 101112195

(51) Int. Cl. G06Q 30/00

(52) U.S. Cl. 705/26.61

(57) ABSTRACT

An information integration interactive system provides information interaction between a mobile device and an information service platform. A user transmits an interactive instruction including product identification information or member data via the mobile device. Upon receiving the interactive instruction, a data inquiry module of the information service platform generates first integrated information for returning to the mobile device. After the mobile device has logged in, a member service module of the information service platform provides second integrated information based on the received interactive instruction, or provides third integrated information based on the member data and a membership level. With the information integration interactive system, not only diverse services can be provided to the user, but the user is also progressively encouraged to provide more personal information. This helps manufacturers, distributors or stores in obtaining the member data as the basis for reducing marketing cost and increasing product benefits.

### BACKGROUND OF THE INVENTION

1. Field of the Invention

The present invention relates to interactive techniques for providing information and integrating member data, and, more particularly, to an information integration interactive system and method that provide information interactive services and perform member information integration through a mobile device.

2. Description of Related Art

With the popularization of network information, product trading not only entails monetary trading, and thus, in the era of electronic information, for the buyers, how to quickly and correctly obtain product information is very important, as to manufacturers, obtaining user information may facilitate follow-up product promotion and in making decisions on marketing strategies.

In an existing sales model, before buying a product, a buyer usually goes online to visit various online sites to search for information in order to understand the content or reviews of the product. Even if the buyer has a particular product in his mind, upon arriving at a store, he may find other products interesting, but lacks the ability to further compare and choose on the spot. After a purchase, the buyer may go to a website to register login profile in order to obtain warranty rights, but at this point the interactions of both parties have reached the end. The above sales model still has a lot of room for improvement. The buyer only sees products after arriving at the store, so it is difficult to know the pros and cons of the products or whether the prices are reasonable without prior inquiries. Therefore, for a buyer inside a store, it is usually difficult to obtain more product information, such as evaluation, pricing, and even product descriptions, or whether a product can be purchased in any other stores nearby, and thus it may be difficult to make a decision in the absence of integrated product information. In addition, after purchase, the product usually comes with a paper manual or guarantee. Often these paper materials are not stored or being misplaced, and cannot be found when needed. If the material is about medicine use, it may be dangerous to take the medicine without knowing the instructions. Thus, the improper storage of user manuals or guaranties after purchase is an issue.

In addition, for manufacturers, distributors or stores, it may be difficult to obtain more useful information through the existing sales model. More specifically, after product has been purchased, the buyer may at most enter personal information online to ensure warranty rights. However, such personal information is usually only available to the upstream manufacturers. But midstream distributors or downstream stores may have little ideas on the conditions the products are sold and buyers' information. In order to protect one's own privacy, a buyer is unlikely to take the initiative to submit personal information to an irrelevant third party. As a result, the distributors are in a bad position to negotiate the purchase of quantity and price with the upstream manufacturers without knowing sales information. It is also challenging for stores to interact with the buyers. Therefore, for manufacturers, distributors or stores, formulation of sales strategies is greatly disadvantaged by the difficulties in obtaining sales or buyers' information. Even if the sales' and buyers' information are available, they may not be up to date. These present challenges to the manufacturers, distributors or stores.

Therefore, there is a need for an information integration mechanism that provides buyers' information to the manufacturers, distributors or stores, thereby providing corresponding data to meet the needs of various ends to help in product sales negotiations and business marketing. However, obtaining personal information necessary for information integration is quite a difficult task, especially after products are sold. How to make buyers take the initiative to provide personal information, thus achieving real-time and more complete services and information integration, is an issue that urgently requires a solution.

### SUMMARY OF THE INVENTION

In light of the foregoing drawbacks, an objective of the present invention is to an information integration interactive system and method that facilitates interactions for product services with users to progressively obtain member data, and feeds back integrated information based on the membership level of the member data.

Another objective of the present invention is to retrieve product identification information from a handheld device to carry out product data inquiry before purchasing, product authenticity check or product-related information download after purchasing, thereby providing a means for obtaining and inquiring real-time information.

In accordance with the above and other objectives, the present invention provides an information integration interactive system that facilitates interactions between a mobile device and an information service platform, wherein the mobile device is used for retrieving a product identification information or inputting a member data to generate an interactive instruction including the product identification information or the member data, and the information service platform includes a member database, a data inquiry module and a member service module. In an embodiment, the member database is used for storing the member data and a membership level corresponding to the member data, the data inquiry module is used for receiving the interactive instruction from the mobile device and generating corresponding first integrated information for returning to the mobile device by analyzing the product identification information, and the member service module is used for receiving the interactive instruction transmitted by the mobile device after a user of the mobile device has logged in to perform interactive services, so as to provide a second integrated information for returning to the mobile device based on the product identification information, or to provide a third integrated information for returning to the mobile device based on the member data or the membership level.

In one implementation aspect, the mobile device obtains the product identification information through barcode scanning, image recognition, voice recognition or manual input.

In another implementation aspect, the data inquiry module and the member service module are connected to an external server via Internet to obtain the first integrated information, the second integrated information and the third integrated information, and the external server can be, for example, a government server, a manufacturer server, a store server or a forum server.

In yet another implementation aspect, the member service module further provides a basic service of the product based on the second integrated information and the product identification information, such as identifying the authenticity of the product. In a further implementation aspect, the information service platform further includes a member analysis module for analyzing the member data based on the membership level and providing required analyzed data to manufacturers, distributors, stores or users.

In yet a further implementation aspect, the information service platform further includes a membership management module for adjusting the membership level according to the member data transmitted by the mobile device.

The present invention further provides an information integration interactive method for information interaction between an information service platform and a mobile device, including the following steps of: having the mobile device perform a logging-in operation to generate a connection; receiving an interactive instruction including a product identification information or member data transmitted by the mobile device; and determining whether the interactive instruction has the product identification information, if yes, providing corresponding second integrated information based on the product identification information; if no, adjusting a membership level based on the member data, and providing corresponding third integrated information based on the member data and the membership level. In an implementation aspect, after the mobile device performs the logging-in operation to generate the connection, the information service platform transmits interactive messages to the mobile device.

In another implementation aspect, the information integration interactive method further includes having the information service platform receive the interactive instruction including the product identification information transmitted from the mobile device, analyzing the product identification information, and generating corresponding first integrated information for returning to the mobile device.

In a further implementation aspect, the information integration interactive further includes analyzing the member data based on the membership level and providing required analyzed data to manufacturers, distributors, stores or users.

Compare to the prior art, the present invention provides an information integration interactive system and method that progressively offer product information and member services to obtain member data by interacting with the user. The user can connect to the information service platform via the mobile device to obtain required product message before purchasing and/or to obtain electronic production information and more services after purchase. In addition, the information service platform provides different product information and services based on different membership levels, so as to entice the user to take the initiative in providing more detailed member data. These member data are integrated into useful information tailored to different entities and provided to manufacturers, distributors or stores as reference for making sales strategies or marketing. Thus, with the information integration interactive system according to the present invention, the interactions between the user and the system not only provides users with required information, also provides manufacturers, distributors or stores with real-time useful member data, reducing marketing cost and increasing product benefits, and meeting the needs of the various entities.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram illustrating an information integration interactive system according to the present invention;

FIG. 2 is a schematic diagram illustrating another embodiment of the information integration interactive system according to the present invention;

FIG. 3 is a schematic diagram illustrating another application embodiment of the information integration interactive system according to the present invention;

FIG. 4 is a schematic diagram illustrating the information integration interactive system according to the present invention utilizing cloud management;

FIG. 5 is a flow chart illustrating a first interaction of an information integration interactive method according to the present invention; and

FIG. 6 is a flow chart illustrating a second interaction of the information integration interactive method according to the present invention.

### DETAILED DESCRIPTION OF THE EMBODIMENTS

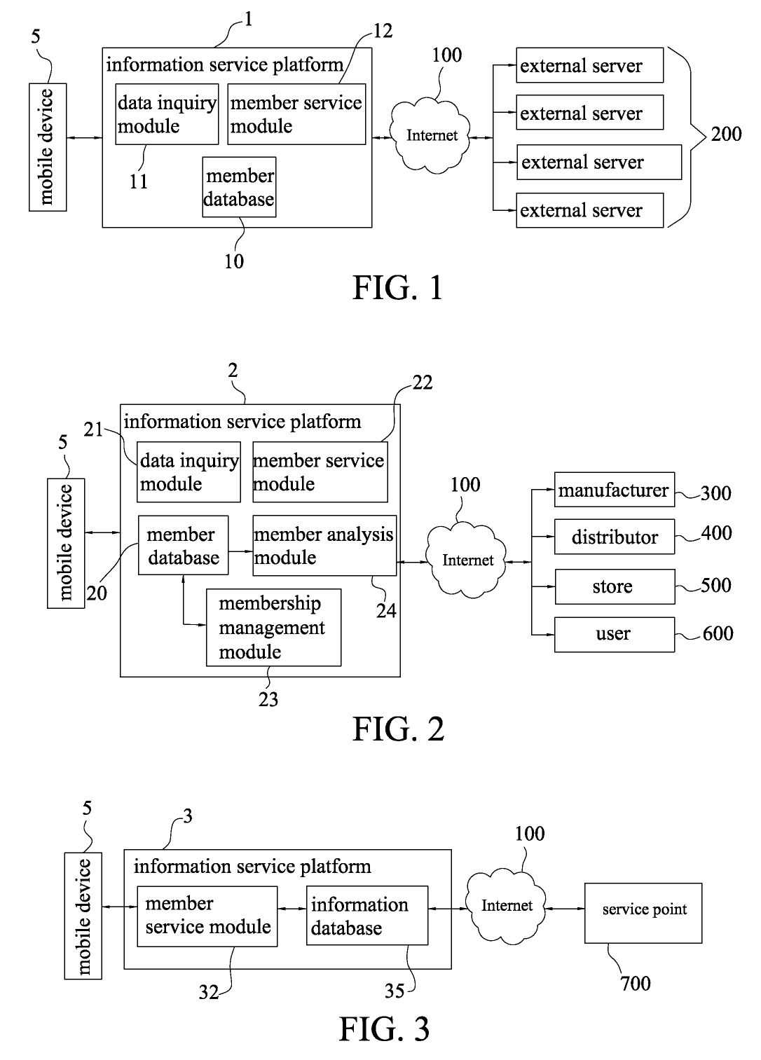

The present invention is described by the following specific embodiments. Those with ordinary skills in the arts can readily understand the other advantages and functions of the present invention after reading the disclosure of this specification. Referring to FIG. 1, a schematic diagram illustrating an information integration interactive system according to the present invention is shown. As shown, the information integration interactive system provides information interaction between a users (or a general user) and an information service platform 1 via a mobile device 5, such that the user may obtain desired production information from the information service platform 1, meanwhile the information service platform 1 can collect and integrate personal information of the user for subsequent use by service providers such as manufacturers, distributors or stores.

The mobile device 5 is used for retrieving production identification information or inputting member profile to generate interactive instructions containing the production identification information or the member profile. More specifically, the mobile device 5 is an interface for the user to inquire information and receive data. The mobile device 5 is installed with an application, which can be connected to the information service platform 1 and send out interactive instructions at different times, so an interactive instruction may contain the production identification information or the member profile. Upon receiving these interactive instructions, the information service platform 1 will return corresponding information or messages. The mobile device 5 may also be an interactive interface such as a web browser to carry out the above operations.

The product identification information refers to a product barcode, a product history, or a unique identification mark that represent the product. There is no limit on its presentation format. It can be a 2D barcode, some numbers or a specific picture, for example. The product identification information is the only and corresponding way of identifying a product. In order to simplify operations, a product specified by the user can be known by directly scanning a barcode. In addition, the product identification information can also be obtained through electronic invoices, that is, the user uses the mobile device 5 to read an electronic invoice in order to know the purchased content on the electronic invoice, and in turn, the product identification information from the purchased content. The present invention thus includes getting the product identification information not only from that printed on the outer casing of the product, but also indirectly from other sources (e.g. an external server 200). In actual implementations, the mobile device 5 may obtain the product identification information by image recognition, voice recognition or manual input. However, these methods are merely illustrative and not limiting. The information service platform 1 may provide data required by the user based on the requirements from the mobile device 5. Connections between the two can be made via mobile communication or wireless communication, thus increasing ways in which the mobile device 5 can be used, as well as providing advantages such as portability and real-time communication. The information service platform 1 may include a member database 10, data inquiry module 11 and a member service module 12.

The member database 10 is used for storing member data or membership level to which the member data corresponds. The information service platform 1 collects user information, so the member database 10 of the information service platform 1 can be used to store member data of the user. Each member data entry has a corresponding membership level, which is the basis used by the information service platform 1 for determining the services to provide or how to reply to users' demands. These will be later discussed in more details.

The data inquiry module 11 is used for receiving the interactive instructions from the mobile device 5, and generating a first integrated data for returning to the mobile device 5 by analyzing the product identification information. The data inquiry module 11 facilitates data inquiry before the user buys a product. Thus, at this time, the user does not need to log in the platform, making it simpler and less restrictive for the user. In operations, the user only needs to transmit the interactive instruction including the product identification information to the information service platform 1, and thereafter, the data inquiry module 11 returns the corresponding first integrated information to the mobile device 5.

The first integrated information described herein refers to the product-related information corresponding to the product identification information, such as the official product information, store selling price and product reviews from other buyers, or even information provided by the government. Moreover, the positioning function of the mobile device 5 can also be used in conjunction to providing store information near the user, such as the address, distance, direction etc., thus providing comprehensive and real-time product information to the user. In order to provide accurate and most up-to-date first integrated information, the information service platform 1 connects to the external server 200 via Internet 100, and retrieves required information from the external server 200. The external server 200 can be a store server, a manufacturer server, a forum server or a government server, for example, which provide useful and real-time information required. Preferably, the data inquiry module 11 displays the first integrated information based on user settings or built-in priorities, so that data that is most important to or most likely required by the user is displayed first.

After the user of the mobile device 5 logs in the platform, the member service module 12 receives the interactive instruction transmitted by the mobile device 5 and performs an interactive service in order to provide a second integrated information based on the product identification information for returning to the mobile device 5, or to provide a third integrated information based on the member data or membership levels for returning to the mobile device 5. The member service module 12 provides information notification and interactive services after product is purchased by the user. Also, different services are provided according to different membership levels. The membership level is based on the amount of member data provided. Under different membership levels, the member service module 12 provides different interactive services. Now, a two-stage scheme is explained as an example.

In the first stage, after the product is bought, the user may connect to the information service platform 1 to carry out member registration. At this time, the user may be required to provide the most basic personal information, such as name or contact method. After the user logs in and transmits the interactive instruction containing the product identification information, the member service module 12 will return the second integrated information to the mobile device 5 of the user. The second integrated information may include a product warranty, a product manual or product-related information. A non-paper warranty or manual is provided to the user, and can be stored directly in the mobile device 5, saving the trouble to later look for them or in case they get lost. The product-related information described herein refers to information that a firmware or software has been updated, thereby notifying the user the current state of the product. In addition, the second integrated information may include an electronic invoice, apart from being easier for the user to store. Since the information service platform 1 also stores the relevant records, it can help the user check whether he/she has won the invoice lottery draw, and notify the user if so. Moreover, since electronic invoices are easier to store, if product return is needed, the chance of losing the invoice and that the product cannot be returned is reduced.

In the second stage, when the user has purchased the product and already left member data in the member database 10 of the information service platform 1, the member service module 12 can send out message to the user or the user can send out interactive instructions via the mobile device 5 to interact with each other. The member service module 12 may transmit the third integrated information to the mobile device 5 based on the interactive instruction, such as a message about product promotion, special sales or additional information. However, the third integrated information is provided according to the membership levels. When the user is interested and wishes to know more about it, he/she has to provide more member data before the information service platform 1 returns the information he/she wants. For example, the user may send out a request for product news to the information service platform 1 via the mobile device 5, the member service module 12 may then respond to the user with a message about a special sale, and if the user wishes to know more about it, such as the time, place and what is on sale, he/she must connect to the information service platform 1 (e.g., by clicking a hyperlink in the message) and provide more member data before getting those information he/she wants. In this way, the user takes the imitative to provide member data, and will not feel disturbed.

With the above two-stage scheme, the information service platform 1 can progressively obtain buyers' personal information. On the other hand, the user may receive information before and after the purchase, whether it is requested by the user or provided by the information service platform 1. In the interaction process, the user can obtain product information in real time, and willingly return member data in return for getting desired information. The information service platform 1 can thus collect and integrate users' member data, which can be provided in real time to the stores, manufacturers or distributors in making marketing or purchase decisions. It should be noted that this embodiment is discussed in the context of the two-stage scheme. However, in actual operations, it is not limited to just two stages, but three or more stages or levels are also applicable.

In addition, the member service module 12 further includes providing basic service of the product based on the second integrated information and the product identification information, such as identifying the authenticity of the product. That is, the member service module 12 may identify, based on the product identification information returned by the user via the mobile device 5 and/or the information obtained from the external server 200, the authenticity of the product purchased by the user and/or information about this product, such as the product warranty period. Moreover, when the warranty period has expired, the member service module 12 may send, for example, a text message to ask the user whether to extend the warranty, thus actively serving the user.

It should be noted that the data inquiry module 11 and the member service module 12 may connect to the external server 200 via Internet 100 to obtain the required first integrated information, the second integrated information or the third integrated information. The first integrated information, the second integrated information or the third integrated information may include public information or private information. Public information may come from government agencies, and private information may come from forums, blogs, or the like. Thus, the information service platform 1 can always provide the latest, real-time and diverse information to the user, which is not achievable by simply using a single portal for searching information.

Referring now to FIG. 2, a schematic diagram illustrating another embodiment of the information integration interactive system according to the present invention is shown. As shown, the information service platform 2 connects and interacts with the mobile device 5. A member database 20, data inquiry module 21 and member service module 22 of the information service platform 2 are the same as the corresponding modules in the information service platform 1. In this embodiment, the information service platform 2 further includes a membership management module 23 and a member analysis module 24.

The membership management module 23 adjusts the membership levels based on the member data transmitted by the mobile device 5. More specifically, a user may wish to know more about a product and therefore transmit more detailed member data, so each time a user uploads or updates the member data, the membership management module 23 will adjust the user's membership level according to the member data contents provided. The membership level indicates how much interactive services the user can get from the information service platform 2. The membership management module 23 determines the membership level of the user through the membership management module 23, such that the member service module 22 can actively send out interactive messages or further determine the membership level in order to respond to the user's request, thereby interacting with the user.

The member analysis module 24 is used to analyze the member data based on the membership level in order to provide a manufacturer 300, a distributor 400, a store 500 or a user 600 the required analyzed data. The analyzed data may be provided in real time or not in real time. The member analysis module 24 will analyze and integrate the member data to convert it into analyzed data, such as, the age groups for purchasing a particular product, the occupation groups for purchasing a particular product, product sales situation and the like. These analyzed data have specific meanings to the manufacturer 300, the distributor 400, the store 500 or the user 600. For example, the manufacturer 300 may wish to know which types of products are popular among young people; the distributor 400 may wish to know the sales situation for a particular product and use it as the basis for purchase negotiation; the store 500 may wish to know which period are product sales peaks or off-season in order to introduce special promotions; even the user 600 may wish to know what products are popular among the same age group. Thus, integrating these analyzed data is very useful. Traditionally, various parties cannot obtain relevant information, but through the analysis and integration of the member analysis module 24, the information becomes readily available. Therefore, the member analysis module 24 analyzes the member data to generate and store the analyzed data, allowing the manufacturer 300, the distributor 400, the store 500 or the user 600 to obtain data tailored to their own needs.

Referring to FIG. 3, a schematic diagram illustrating another embodiment of the information integration interactive system according to the present invention is shown. As shown, the information service platform 3 connects and interacts with the mobile device 5. The information service platform 3 not only provides information to the mobile device 5, but also acts as a means to which the mobile device 5 can inquire data.

More specifically, if a product is broken and needs fixing, the user may inquire information service platform 3 via the mobile device 5 about information of any nearby service point, such as the address, how to get there, reviews and the like. After the product is sent to the service point 700, the service point 700 may report maintenance information back to the information service platform 3, which is stored in an information database 35, for example. At this time, the user only needs to connect to the information service platform 3 to inquire about the repair status through a member service module 32. More specifically, the information service platform 3 has user's personal information, so the user may ask the service point 700 to use the information service platform 3 as the contact medium, which makes it easy for the user to inquire data. Traditionally, inquiring product data, product reviews, product price or repair information require the user going to different service platforms, but with the information service platform 3, all these services are integrated together, so it is desirable for the user.

Furthermore, the mobile device 5 may feedback information to the information service platform 3. More specifically, apart from passively waiting for message notification, the mobile device 5 can actively send out messages, such as ratings or reviews of a product, to the information service platform 3, which manages and stores them in the information database 3 for further use by other users. This information can also be provided in addition to the first integrated information.

In addition, the mobile device 5 includes an information display interface (not shown) for displaying a history list of the first integrated information, the second integrated information or the third integrated information in the mobile device 5. More specifically, through the information display interface, the user may obtain previously inquired relevant data, which includes a history list of the first integrated information, the second integrated information and the third integrated information etc. The history list can be appropriately ranked based on user's settings, where information with a higher priority is displayed first. Thus, the user does not need to ask the information service platform 3 for information each time.

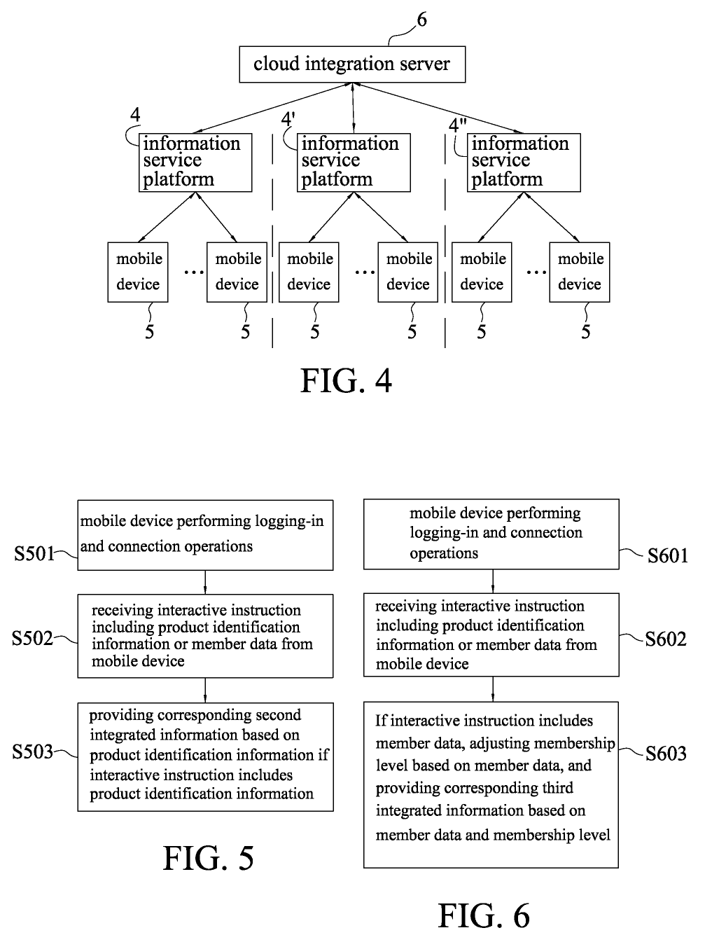

Referring to FIG. 4, a schematic diagram illustrating the information integration interactive system according to the present invention utilizing cloud management is shown. As shown, in order to increase overall efficiency of the information integration interactive system, services are provided based on different regions and different hierarchies. Each mobile device 5 can be connected to an information service platform 4, 4′ or 4″ in its region, while each information service platform 4, 4′ and 4″ is connected to a cloud integration server 6. There is a hierarchical relationship between the information service platforms 4, 4′ and 4″ and the cloud integration server 6, and there are different regions among the information service platforms 4, 4′ and 4″. As such, regional information such as local store message, maps or nearby service points can be stored in appropriate information service platform 4, 4′ and 4″. Distributed storage avoids operational loads being concentrated on a single information service platform, and region-wise services speed up the retrieval of regional data. On the other hand, integrated information such as member data or product messages can be stored in the cloud integration server 6.

Referring to FIG. 5, a flow chart illustrating a first interaction of an information integration interactive method according to the present invention is shown. In step 501, a mobile device is logged in and connected. In step S502, an interactive instruction including product identification information or member data is received from the mobile device, that is, an interactive instruction is transmitted by the mobile device. Finally, in step S503, if it is determined that the interactive instruction includes the product identification information, corresponding second integrated information is provided based on the product identification information. This process indicates that after a product is purchased, the user interacts with the information service platform using the product identification information, so when the information service platform determines the interactive instruction includes the product identification information, it returns the second integrated information to the mobile device, thereby completing interactions between the two.

Referring to FIG. 6, a flow chart illustrating a second interaction of the information integration interactive method according to the present invention is shown. In step 601, a mobile device is logged in and connected. Then, in step S602, an interactive instruction including product identification information or member data is received from the mobile device, that is, an interactive instruction is transmitted by the mobile device. Finally, in step S603, if it is determined that the interactive instruction includes the member data, a membership level is adjusted based on the member data, and corresponding third integrated information is provided based on the member data and the membership level. This process indicates that after the member data is uploaded by the user, the information service platform adjusts the membership level based on the member data contents, and provides the third integrated information based on the current membership level. Therefore, when the information service platform determines the interactive instruction includes the member data, it upgrades the membership level and appropriately returns the third integrated information to the mobile device, thereby providing a more complete service to the user.

In the flow charts of FIGS. 5 and 6, upon receiving the interactive instruction including the product identification information from the mobile device, the information service platform analyzes the product identification information in order to generate corresponding first integrated information for returning to the mobile device. This indicates that before buying a product, the user may obtain the first integrated information through the interactive instruction including the product identification information. The first integrated information may be, for example, product reviews, product price comparison, nearby retailers and the like. As a result, the user may obtain product information in real time without location restriction.

Moreover, in the flowchart of FIG. 5, after the second integrated information is provided corresponding to the product identification information, a basic service of the product is provided based on the second integrated information and the product identification information, such as identifying authenticity of the product. More specifically, by comparing the product identification information uploaded by the user and the second integrated information from the external server, the authenticity of the product can be determined Alternatively, more detailed production information is provided, such as medicine ingredients, product structure etc., but not production information normally available before product purchase.

Furthermore, in the flow charts of FIGS. 5 and 6, the member data is analyzed based on the membership level so as to provide analyzed data required by the manufacturers, distributors, stores or the users. The analyzed data may be provided in real time or not in real time. As mentioned previously, since the user may wish to get more production messages or services, he/she may return more detailed member data. In doing so, the member data can be collected, analyzed and integrated, and the analyzed data are then provided to the manufacturers, distributors, stores or the users as the basis for subsequent manufacturing, sales, marketing or purchasing.

In summary, the present invention provides an information integration interactive system and method that progressively obtains member data by providing users with useful information. The user can connect to the information service platform via the mobile device to obtain required product message before purchasing and to obtain electronic production information after purchase. Meanwhile, the information service platform provides different product information and services based on different membership levels, so as to entice the user to provide more detailed member data. Finally, these member data are integrated into useful information and provided to manufacturers, distributors or stores as reference for sales or marketing. Thus, the information integration interactive system according to the present invention not only provides users with required information, also provides manufacturers, distributors or stores with real-time useful member data, which satisfies the data required by different entities.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. An information integration interactive system, comprising:
a mobile device for retrieving a product identification information of a product or inputting a member data to generate an interactive instruction including the product identification information or the member data; and
an information service platform connected with the mobile device, including:
a member database for storing the member data and a membership level corresponding to the member data;
a data inquiry module for receiving the interactive instruction from the mobile device and generating a corresponding first integrated information for returning to the mobile device by analyzing the product identification information; and
a member service module for receiving the interactive instruction transmitted by the mobile device after a user of the mobile device has logged in to perform interactive services, so as to provide a second integrated information for returning to the mobile device based on the product identification information, or to provide a third integrated information for returning to the mobile device based on the member data or the membership level.

2. The information integration interactive system of claim 1, wherein the mobile device obtains the product identification information through barcode scanning, image recognition, voice recognition or manual input.

3. The information integration interactive system of claim 1, wherein the data inquiry module and the member service module are connected to an external server via Internet to obtain the first integrated information, the second integrated information and the third integrated information.

4. The information integration interactive system of claim 1, wherein the member service module further provides a basic service of the product based on the second integrated information and the product identification information.

5. The information integration interactive system of claim 1, wherein the second integrated information includes product warranties, product manuals and/or product-related information.

6. The information integration interactive system of claim 1, wherein the first integrated information, the second integrated information or the third integrated information includes public information and private information.

7. The information integration interactive system of claim 1, wherein the information service platform further includes a member analysis module for analyzing the member data based on the membership level and providing required analyzed data to manufacturers, distributors, stores or users.

8. The information integration interactive system of claim 1, wherein the information service platform further includes a membership management module for adjusting the membership level according to the member data transmitted by the mobile device.

9. The information integration interactive system of claim 1, wherein the mobile device transmits feedback data to the information service platform.

10. The information integration interactive system of claim 1, wherein the mobile device includes an information display interface for displaying a history list of the first integrated information, the second integrated information or the third integrated information in the mobile device.

11. An information integration interactive method for information interaction between an information service platform and a mobile device, comprising the following steps of:
performing, by the mobile device, a logging-in operation to generate a connection;
receiving an interactive instruction having a product identification information of a product or member data transmitted by the mobile device; and
determining whether the interactive instruction has the product identification information; if yes, providing a corresponding second integrated information based on the product identification information; if not, adjusting a membership level based on the member data of the interactive instruction, and providing a corresponding third integrated information based on the member data and the membership level.

12. The information integration interactive method of claim 11, wherein, after the mobile device performs the logging-in operation to generate the connection, the information service platform transmits interactive messages to the mobile device.

13. The information integration interactive method of claim 11, further comprising receiving, by the information service platform, the interactive instruction having the product identification information transmitted from the mobile device, analyzing the product identification information, and generating a corresponding first integrated information for returning to the mobile device.

14. The information integration interactive method of claim 11, further comprising, after providing the corresponding second integrated information based on the product identification information, providing a basic service of the product based on the second integrated information and the product identification information.

15. The information integration interactive method of claim 11, further comprising analyzing the member data based on the membership level and providing required analyzed data to manufacturers, distributors, stores or users.
